(19) United States
(12) Patent Application Publication
(10) Pub. No.: US 2008/0314195 A1
(43) Pub. Date: Dec. 25, 2008

(54) Starter for engines

(75) Inventors: Shinji Andoh, Nagoya (JP); Kazuhiro Andoh, Okazaki-shi (JP); Tadahiro Kurasawa, Chita-gun (JP); Yamato Utsunomiya, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-city (JP)

(21) Appl. No.: 12/213,438

(22) Filed: Jun. 19, 2008

(30) Foreign Application Priority Data
Jun. 21, 2007 (JP) 2007-164061
Oct. 16, 2007 (JP) 2007-269125

(51) Int. Cl. F02N 11/00

(52) U.S. Cl. 74/7 C

(57) ABSTRACT

The clutch outer 24 is formed in the planet carrier 24 that outputs the orbital motion of the planetary gear 23, and the outer regulating part 33 is formed in the central part of the planet carrier 24.

In the outer regulating part 33, he round hole 33a is formed in the central part of the direction of the diameter. The anti-motor side of the armature shaft 2 is inserted through the round hole 33a.

The end part of the armature shaft 2 is inserted into the inside of the concave section 26b that passes through the round hole 33a provided on the outer regulating part 33. The armature shaft bearing 34 that is press fit in the inner circumference of the concave section 26b supports the armature shaft 2 relatively rotatable.

Consequently, the deflection of the armature shaft 2 can be controlled, and the deflection of the clutch outer 24 can be controlled in the range of the smooth torque transfer of the one-way clutch 7.

### CROSS-REFERENCE TO RELATED APPLICATION

This application is based on and claims the benefit of priority from earlier Japanese Patent Application No. 2007-164061 filed Jun. 21, 2007, and Japanese Patent Application No. 2007-269125 filed Oct. 16, 2007, the description of which is incorporated herein by reference.

### BACKGROUND OF THE INVENTION

1. Technical Field of the Invention

The present invention relates to a starter for starting engines.

2. Description of the Related Art

As shown in Japanese Patent Application Laid-Open Publication No. 2005-130753 and FIG. 9, there is a conventional starter for starting an engine provided with a speed reducer 105, which slows down the revolving speed of an armature 100, and a one-way clutch 115 that transmits the rotation of the armature 100 slowed down by the speed reducer 105 to an output shaft 110.

An end case (not shown) supports one end (anti-speed reducer side) of an armature shaft 120 that outputs the rotational force (torque) of the armature 100 via a bearing (not shown). A dust protecting plate 140 supports the other end of the armature shaft 120 via a bearing 130.

The speed reducer 105 is a planetary speed reducer, and is comprised of a sun gear 150 provided on the armature shaft 120, an internal gear 160 arranged coaxially to the sun gear 150, a plurality of planetary gears 170 that engage to both the gears 150 and 160, and a carrier 180 that receives force from the orbital motion of the planetary gears 170.

The one-way clutch 115 is formed in the carrier 180. The one-way clutch 115 is comprised of a clutch outer 200 which is supported relatively freely rotatable at one end of the armature shaft 120 via a bearing 190, a clutch inner 210 formed on the output shaft 110 as one, and a plurality of rollers 220 arranged between the clutch outer 200 and the clutch inner 210.

According to the above-mentioned composition, deflection of the clutch outer 200 caused by the rotation of the armature 100 can be controlled, and it is possible to transfer the torque to the one-way clutch 115 smoothly even if the clutch outer 200 is unbalanced.

On the other hand, as shown in Japanese Patent Application Laid-Open Publication No. 9-88780 and FIG. 9, there is a conventional starter comprising the output shaft 110 supported rotatably via a bearing 250 provided on the front housing 240 and a bearing 270 provided on the center housing 260. The output shaft 110 has a pinion gear 230 provided coaxially, and is formed as one in the clutch inner 210 of the one-way clutch 115.

However, the above mentioned starter is controlling the deflection of armature 100 by arranged the bearing 130 to one end (anti-clutch side of the sun gear 150) of the armature shaft 120. In this case, since it was necessary to secure the space (‘X’ in FIG. 9) for arranging the bearing 130 between the armature 100 and the speed reducer 105, there was a problem where the length of the starter becomes long.

Further, when the engine speed exceeds the starter speed and causes the pinion gear 230 into the overrun state after the engine has started by the starter, there will be a problem, as shown in FIG. 10, that the deflection of the output shaft 110 in the inclined state occurs easily from small instabilities in the rapidly rotating clutch inner 210.

Moreover, if such deflection of the output shaft 110 arises, problems such as the noise occurrence by vibration, rotational instability of the clutch inner 210 transferred to the clutch outer 200 via the rollers 220, and worsening the idling performance of the one-way clutch 115 will arise.

For this reason, the clearance of the bearings must to be made small and the balances of the revolving parts, such as the output shaft 110 or the clutch outer 200, must to be finished with a sufficient accuracy.

### SUMMARY OF THE INVENTION

The present invention has been made in order to solve the issue described above, and has as its object to provide a starter for engines that can control the deflection of a clutch outer, and can shorten the length of the starter.

Another object of the present invention is to provide a starter for engines that can prevent the deterioration of the idling performance by regulating the inclination of an output shaft with simple construction.

In the starter for engines according to a first aspect, a starter for engines comprising a electric motor that generates a torque and has an armature shaft, a planetary speed reducer that has a sun gear and a planetary gear, wherein the sun gear is provided on the armature shaft, and the planetary gear revolves around a circumference of the sun gear while the planetary gear rotates in order to reduce the revolving speed of the armature shaft, a one-way clutch. This clutch transmits the torque of the electric motor increased by the speed reducer to an output shaft, and has a clutch outer and a clutch inner provided relatively rotatable, a wedge-shaped cam chamber formed between the clutch outer and the clutch inner, and a roller contained in the cam chamber, a planet carrier formed as one with the clutch outer which is driven by the orbital motion of the planetary gear, an outer regulating part having a round hole formed in the central part of the planet carrier in the direction of its diameter, and a concave section drilled in the central part of the clutch inner that is supported by a center housing rotatably via an inner bearing, wherein an end of the armature shaft, disposed on the one-way clutch side from the part where the sun gear is provided, passes through the round hole of the outer regulating part and is inserted into an inner circumference of the concave section, and is supported relatively rotatably by the clutch inner via an armature shaft bearing.

According to the above-mentioned composition, the housing supports via the inner bearing the clutch inner, and the end of the armature shaft is supported by the clutch inner via the armature shaft bearing. That is, the housing aligns the clutch inner via the inner bearing, and the end of the armature shaft is supported by the clutch inner via the armature shaft bearing, thus the deflection of the armature shaft may be controlled.

Further, by arranging the armature shaft bearing to the inner circumference of a concave section formed in the clutch inner, it is not necessary to arrange the armature shaft bearing to the anti-clutch side of the sun gear. Consequently, it is possible to shorten the length of the starter.

Moreover, by having the end of armature shaft pass through the round hole of the outer regulating part provided in the central part of the planet carrier the armature shaft can control the deflection of the clutch outer.

In the starter for engines according to a second aspect, wherein suppose a size difference of the inner diameter of the round hole of the outer regulating part and the outer diameter of the armature shaft which passes through the round hole is 2a, a bearing clearance in the inner circumference or perimeter side of the armature shaft is 2b, and an amount of a maximum separation which the rollers can separate from a perimeter side of the clutch inner at the time of overrun of the one-way clutch is set to c, the condition given by the formula c>a+b is satisfied.

In the starter for engines according to a third aspect, wherein suppose an amount of a maximum eccentric value of the clutch outer produced when the two rollers which adjoin each other in the direction of a circumference dig into narrower sides of the cam chambers is set to d, the condition given by the formula a+b>d is satisfied.

In the starter for engines according to a fourth aspect, wherein the clutch outer is provided with a through hole formed in the central part of the diameter direction of the planet carrier, and the outer regulating part having a ring form is inserted into the inner circumference of the through hole.

In the starter for engines according to a fifth aspect, the inner bearing is arranged contactably to the clutch inner.

In the starter for engines according to a sixth aspect, an end face of the inner bearing is countering and arranged contactably to an end face of the clutch inner.

In the starter for engines according to a seventh aspect, the inner bearing is located where it overlaps an inside of a washer, which prevents the clutch inner from escaping and coming out in the direction of the axis against the clutch outer.

In the starter for engines according to an eighth aspect, wherein suppose a crevice between an edge surface of the clutch inner and an edge surface of the inner bearing in the state where the output shaft is located in the electric motor side of the center housing is set to e, and a thickness of the washer is set to f, the condition given by the formula e<f is satisfied.

In the starter for engines according to a ninth aspect, a flange part, which projects outward the direction of its diameter, is provided in the electric motor side end of the inner bearing.

In the starter for engines according to a tenth aspect, a chamfer is provided in an inner surface of the flange part.

In the starter for engines according to an eleventh aspect, wherein a concave groove along the perimeter of the output shaft is provided in the anti-motor side of the clutch inner, and at least a part of the inner bearing is fit into the concave groove of the clutch inner.

### BRIEF DESCRIPTION OF THE DRAWINGS

In the accompanying drawings:

FIG. 1 is an axial sectional view showing a starter according to a first embodiment of the present invention;

FIG. 2 is an axial sectional view showing the principal part of the starter shown in FIG. 1;

FIG. 3 is an expanded sectional view of a one-way clutch portion shown in FIG. 1;

FIG. 4 is an expanded axial sectional view showing a circumference of the one-way clutch shown in FIG. 1;

FIG. 5A and 5B each is a sectional view showing a cam chamber of the one-way clutch shown in FIG. 1;

FIG. 6 is an axial sectional view showing a principal part of the starter according to a second embodiment of the present invention;

FIG. 7 is an axial sectional view showing the circumference of the clutch according to a third embodiment of the present invention;

FIG. 8 is an axial sectional view showing a bearing and a clutch inner according to a fourth embodiment of the present invention;

FIG. 9 is a sectional view of the starter concerning the conventional technology; and

FIG. 10 is a mimetic diagram for explaining the circumference of deflection of an output shaft in the conventional technology.

### DETAILED DESCRIPTION OF THE PREFERRED EMBODIMENTS

With reference to the accompanying drawings, hereinafter will be described a first embodiment of the present invention.

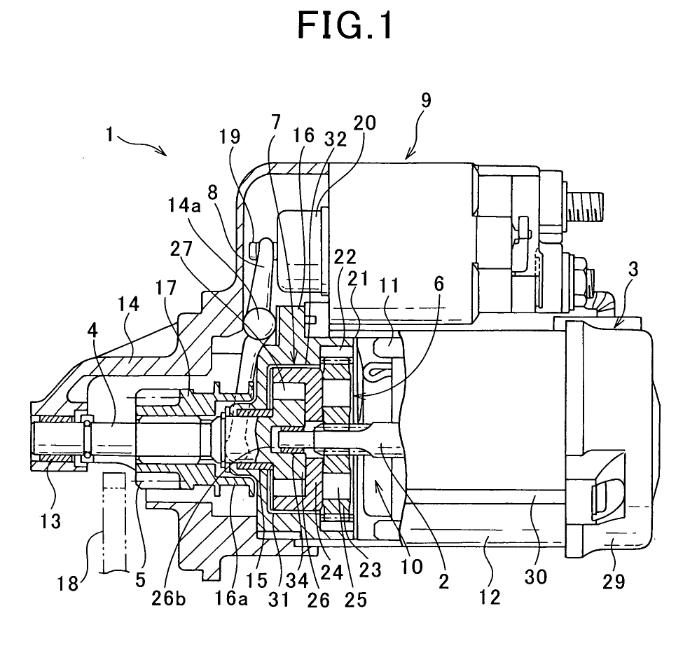

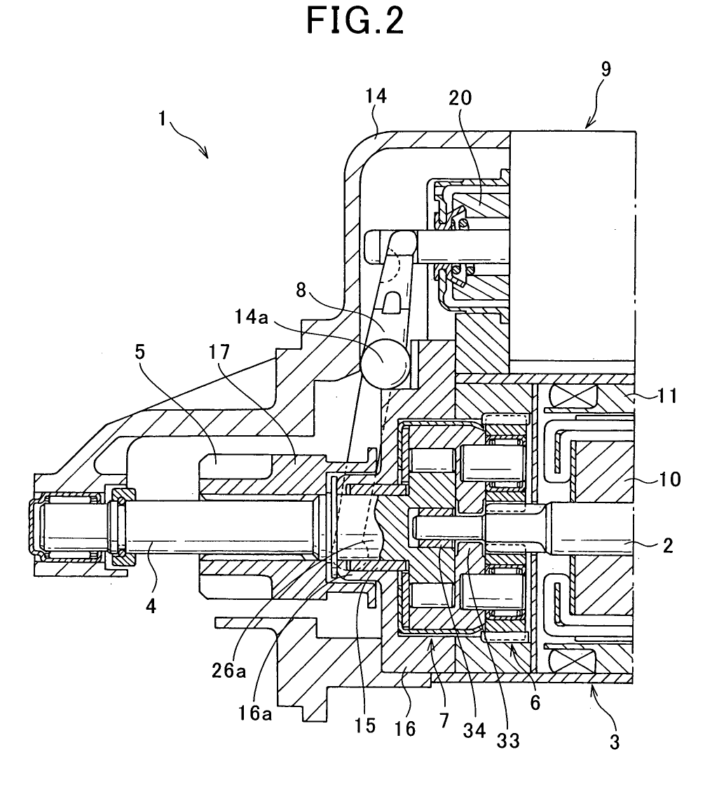

FIG. 1 is an axial sectional view showing a starter according to the first embodiment, and FIG. 2 is an axial sectional view showing a principal part of the starter.

The starter 1 of this embodiment is comprised of an armature shaft 2, an electric motor 3, an output shaft 4, a pinion gear 5, a planetary speed reducer 6 (shortened to “speed reducer” hereafter), a one-way clutch 7, a shift lever 8, and a magnetic switch 9.

The electric motor 3 makes the armature shaft 2 generate torque in response to an energization. The output shaft 4 is arranged coaxially to the armature shaft 2 at the front side (left side of FIGS. 1 and 2) of the electric motor 3. The pinion gear 5 is engaged in twist-spline manner on the perimeter of the output shaft 4. The speed reducer 6 slows down the revolving speed of the electric motor 3. The one-way clutch 7 transmits the torque of the speed reducer 6 to the output shaft 4. And the magnetic switch 9 opens and closes a main point of contact (not shown) provided in an energization circuit (not shown) of the electric motor 3 and it moves the pinion gear 5 in the direction of an axis via the shift lever 8.

The electric motor 3 is a commonly known commutator motor that has a commutator (not shown) in one end (anti-speed reducer side) of the armature shaft 2. The electric motor 3 is comprised of an armature 10 which has the armature shaft 2, a fixed magnetic pole 11 arranged at the perimeter of the armature 10, and a cylindrical yoke 12 that fixes the fixed magnetic pole 11 in its inner surface. The armature 10 is energized and starts rotating when a point of contact (not shown) built in the magnetic switch 9 is closed by switching a starter switch (not shown) to “ON”.

A front end (anti-motor side) of the output shaft 4 is supported rotatably by one end of a front housing 14 freely via a bearing 13. A rear end (motor side) of the output shaft 4 is supported rotatably by a center housing 16 via an inner bearing 15. The inner bearing 15 is being fixed so that its rear end projects into the inner surface of a small diameter cylinder part 16a provided at the front end of the center housing 16. The inner bearing 15 is made of metal or resin, for example.

The pinion gear 5 and a spline tube 17 are formed as one piece that is provided on the perimeter of the output shaft 4 via twist-spline engagement. This pinion gear 5 may be engaged with a ring gear 18 of an engine (not shown) by pushing the spline tube 17 forward on the output shaft 4 along with the twist-spline via the shift lever 8. The intermediate part of the shift lever 8 is supported swingably by a support part 14a of the front housing 14, while the one end of the shift lever 8 engages with the perimeter of the spline tube 17, and the other end engages with a rod 19 which projects toward the front side of the magnetic switch 9.

When the above-mentioned starter switch is switched to “ON”, a coil (not shown) is energized and by the magnetism generated in the coil, a plunger 20 accommodated inside the magnetic switch 9 is attracted therein. Consequently, the point of contact of the electric motor 3 is closed, and a shifting operation of the shift lever 8 is carried out through the rod 19, then the extrusion power of the pinion gear 5 is generated.

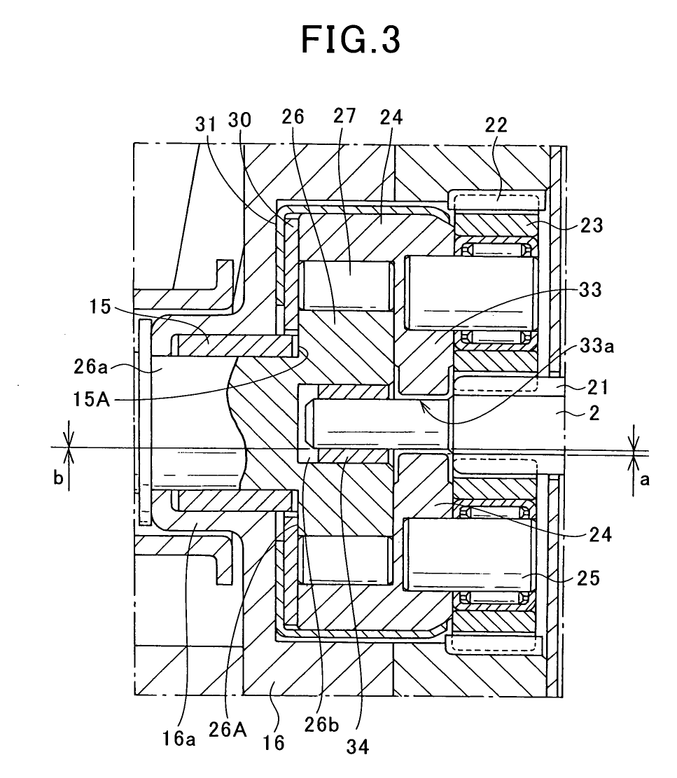

The speed reducer 6 is a commonly known planetary speed reducer type that slows down the revolving speed of the electric motor 3 on the armature shaft 2 on the same axle, and increases output torque. As shown in FIG. 3, the speed reducer 6 is comprised of a sun gear 21 formed in the perimeter of one end (anti-motor side) of the armature shaft 2, an internal gear 22 arranged in a ring shape coaxially with the sun gear 21, a plurality of, three for example, planetary gears 23 that engage to both the sun gear 21 and the internal gear 22, and a planet carrier 24 that is rotated by the orbital motion of these planetary gears 23. The sun gear 21 transmits the rotation of the armature shaft 2 to three planetary gears 23 by rotating together with the armature shaft 2.

Each of three planetary gears 23 are supported rotatably via bearings (not shown) by pins 25 fixed to the planet carrier 24 separately. The planetary gears 23 are engaged with the sun gear 21 and the internal gear 22, and revolve around the perimeter of the sun gear 21. Moreover, the internal gear 22 is formed in the inner surface of the cylindrical wall of the center housing 16. The planet carrier 24 of the one-way clutch 7 is accomplished with a clutch outer 24 as one body (the same number is given as the planet carrier 24) that rotates when the revolution power of the planetary gears 23 is transmitted. Furthermore, three pins 25 are fixed to the planet carrier 24.

As shown in FIG. 3, the one-way clutch 7 is comprised of the clutch outer 24 provided as one body as the planet carrier 24, a clutch inner 26 provided as the output shaft 4, and a plurality of rollers 27 and springs 28 that transfer the torque among both the clutch outer 24 and the clutch inner 26. The center housing 16 covers the perimeter of the speed reducer 6 and the one-way clutch 7, and is pinched between the front housing 14 and an end case 29 with the yoke 12. The whole center housing 16 is fixed by a plurality of through bolts 30.

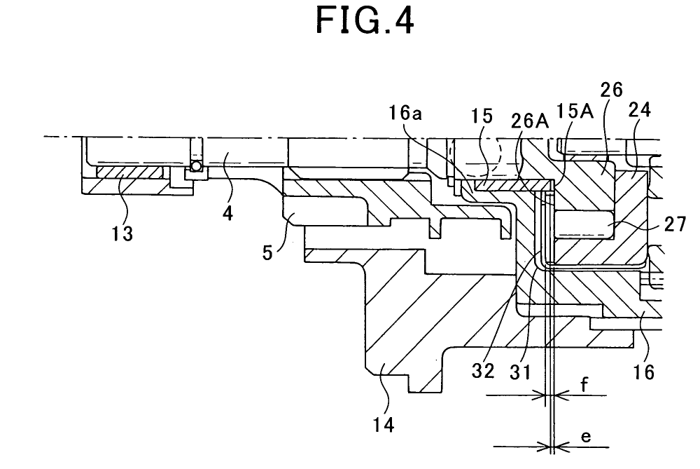

FIG. 4 is the expanded axial sectional view showing the circumference of the one-way clutch 7. As shown in FIG. 4, the one-way clutch 7 is provided with a washer 31 for preventing the clutch inner 26 from falling out, and the outflow of lubricous grease. The perimeter part of the washer 31 which contacts the end surface of the clutch outer 24 is fixed by the clutch cover 32 and the inner periphery of the washer 31 contacts the clutch inner 26, which prevents the clutch inner 26 from falling out (leftward in the figure) and prevents the grease to outflow.

Here, above mentioned inner bearing 15, which is arranged with its end part projected into the small diameter cylinder part 16a provided at the front end of the center housing 16, has a side edge surface 15A contactably arranged facing the end surface 26A of the clutch inner 26, and the inner bearing 15 is arranged overlapping the inner diameter side of the washer 31.

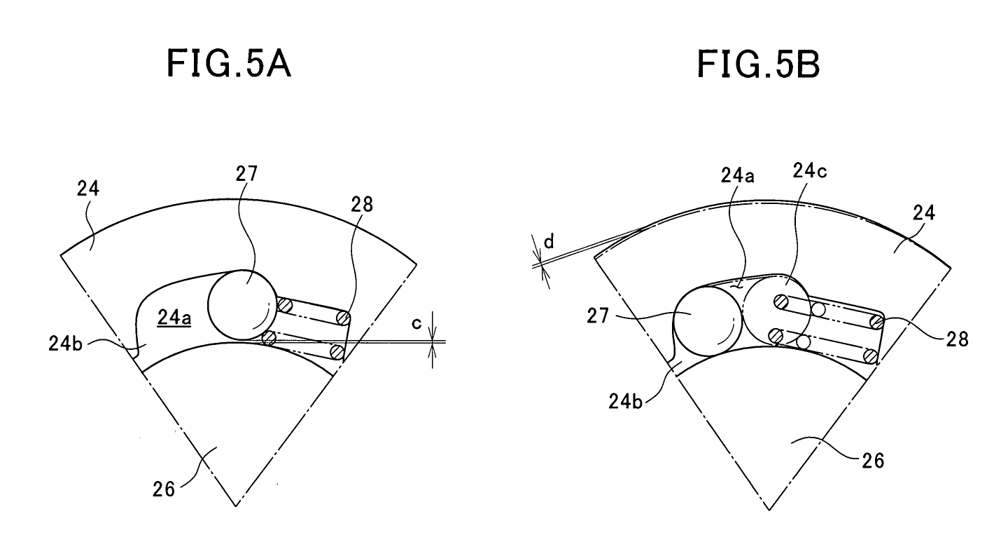

As for the clutch outer 24, an outer regulating part 33 is formed in the central part of the planet carrier 24 part of the clutch outer 24, and the deflection in the direction of its diameter is controlled by the outer regulating part 33. As shown in FIG. 3, a round hole 33a is formed in the central part of the outer regulating part 33 in the direction of its diameter, and the end part of the armature shaft 2 is inserted into the round hole 33a. Further, there are a plurality of wedge-shaped cam chambers 24a (refer to FIGS. 5A and 5B) formed inside the clutch outer 24 at equal intervals in the direction of the circumference of the clutch outer 24 between the perimeter sides of the clutch inner 26, and the rollers 27 are contained in the cam chambers 24a.

The rollers 27 are formed in rod form, and when the clutch outer 24 rotates, the rollers 27 are pushed against the narrower part of the cam chambers 24a to lock the clutch outer 24 and the clutch inner 26, and then the rollers 27 will transmit the rotation of the clutch outer 24 to the clutch inner 26. The springs 28 are accommodated in the cam chambers 24a together with the rollers 27, and are pressing the rollers 27 to the narrower sides 24b of the cam chambers 24a.

The clutch inner 26 is provided with an inner axis part 26a with its outer diameter smaller than its inner perimeter side which contacts the rollers 27 at the time of torque transfer. This inner axis part 26a is provided as one body on output shaft 4, and is supported by the center housing 16 rotatably via the inner bearing 15 that fits into the perimeter of the inner axis part 26a. Moreover, the center housing 16 fits into the inner circumference of the front housing 14 attached to the engine, and is fixed unrotatably.

As shown in FIG. 3, a hollow pipe-like concave section 26b is drilled in the central part in the clutch inner 26 along the direction of its axis. Further, an armature shaft bearing 34, which supports the front-end part of the armature shaft 2, is press fit into the inner circumference of the concave section 26b. That is, the anti motor side of the armature shaft 2 passes through the round hole 33a of the outer regulating part 33 and inserted into the inner circumference of the concave section 26b, and is supported relatively rotatably by the clutch inner 26 via the armature shaft bearing 34. Moreover, the motor side of the armature shaft 2 is supported rotatably by the end case 29 via a bearing (not shown).

Here, the conditions for controlling the transfer of torque via the clutch outer 24 are explained referring FIG. 3, FIG. 4 and FIGS. 5A and 5B.

Suppose the size difference of the inner diameter of the round hole 33a of the outer regulating part 33 and the outer diameter of the armature shaft 2 which passes through the round hole 33a is 2a, the size difference (bearing clearance) of the inner diameter of the armature shaft bearing 34 and the outer diameter of the armature shaft 2 is 2b, the amount of the maximum separation by which the rollers 27 can separate from the perimeter side of the clutch inner 26 at the time of overrun of the one-way clutch 7 is c, and the amount of the maximum eccentric value of the clutch outer 24 produced when the two rollers 27 which adjoin each other in the direction of a circumference dig into the narrower sides 24b of the cam chambers 24a is d,

c>a+b (1)

a+b>d (2)

The condition given by the above formula (1) and formula (2) are satisfied.

Here, the bearing clearance 2b is the size difference of the inner diameter of the armature shaft bearing 34 and the outer diameter of the armature shaft 2 when the armature shaft bearing 34 is pressed fit into the inner circumference of the concave section 26b. Further, the bearing clearance 2b is the size difference of the outer diameter of the armature shaft bearing 34 and the inner diameter of the concave section 26b when the armature shaft bearing 34 is pressed fit into the perimeter of the armature shaft 2.

Moreover, as shown in FIG. 4, suppose the width of a crevice between the edge surface 26A of the clutch inner 26 and the edge surface 15A of the inner bearing 15 in the state where the output shaft 4 is located in the rear side of the center housing 16 is e, and the thickness of the washer 31 is f,

e<f (3)

The condition given by the above formula (3) is satisfied.

Next, the operation of starter 1 is explained.

When the starter switch is turned “ON”, the point of contact of the electric motor 3 is closed by the magnetic switch 9 and the armature 10 is energized, thus torque will occur in the armature 10. Thereby, with the armature shaft 2, the sun gear 21 rotates and three planetary gears 23 are rotated. Although each planetary gears 23 is engaged with the sun gear 21 as well as the internal gear 22, each planetary gears 23 revolves by itself centering the pins 25 and revolves the perimeter of the sun gear 21 simultaneously since the internal gear 22, which is formed in the center housing 16, is structured not to rotate. The rotation power is then transmitted to the planet carrier 24 (namely, the clutch outer 24) via the pins 25, and the rotation of the clutch outer 24 is transmitted to the clutch inner 26 via the rollers 27, thus the output shaft 4 rotates.

On the other hand, by switching the starter switch “ON”, a magnetic coil (not shown) built in the magnetic switch 9 is energized and an electromagnet is formed. As the plunger 20 (refer to FIG. 1) is pulled into the electromagnet, the pinion gear 5 which fits into the output shaft 4 is pushed forward (left of FIG. 1) by the shift lever 8 on the axis of the output shaft 4 together with the spline tube 17 and engages to the ring gear 18, thus the torque of the electric motor 3 is transmitted to the ring gear 18 and cranks the engine.

After the engine has started and the pinion gear 5 is turned at high speed by the ring gear 18, the rotation of the clutch inner 26 will become faster than the rotation of the clutch outer 24. However, the rollers 27 move to the larger side 24c of the cam chambers 24a between the clutch inner 26 and the clutch outer 24, which cancels the lock of the clutch inner 26 and the clutch outer 24. Therefore the torque will not be transmitted to the clutch outer .24 from the clutch inner 26, thus the overrun of the armature 10 can be prevented.

Further, after the engine has started by cranking and the starter switch is turned “OFF”, the energization to the magnetic coil will be stopped, and when the attractive force of the electromagnet disappears, the plunger 20 will be pushed back by the reactive force of the return spring (not shown). When the plunger 20 is pushed back, the pinion gear 5 is disengaged from the ring gear 18 by the shift movement of the shift lever 8 that is an opposite direction for starting the engine. The pinion gear 5 then returns back to the predetermined position (the position shown in FIG. 1) on the output shaft 4 and stops. Furthermore, the main point of contact opens and the energization to the electric motor 3 from a battery (not shown) is stopped, thus rotation of the armature 10 slows down gradually and stops.

As explained above, it is clear that the starter 1 of the present embodiment can control the deflection of the armature shaft 2 since the clutch inner 26 is aligned by the center housing 16 via the inner bearing 15, and the front end part of the armature shaft 2 is supported by the clutch inner 26 via the armature shaft bearing 34. Further, the length of the starter 1 can be shortened because it is not necessary to allocate space for arranging the armature shaft bearing 34 to the anti-clutch side of the sun gear 21 by arranging the armature shaft bearing 34 to the inner circumference of the concave section 26b formed in the clutch inner 26. Furthermore, the alignment regulation of the clutch outer 24 can be carried out within the range of the smooth torque transfer of the one-way clutch 7, because the relations between the above formula (1) and formula (2) are satisfied.

That is, by satisfying the condition of formula (1), the deflection of the clutch outer 24 can be controlled at the time when the revolving speed of the clutch inner 26 is exceeding (overrunning) the revolving speed of the clutch outer 24.

Further, by satisfying the condition of formula (2), the two rollers 27 can be prevented from being locked when the clutch outer 24 is in the condition of decentering because the outer regulating part 33 does not become a harmful influence when the rollers 27 dig into the narrower spaces 24b of the cam chambers 24a. In other words, smooth torque transfer can be performed since the operation of the one-way clutch 7 is not obstructed by the outer regulating part 33.

Furthermore, according to this embodiment, the returning power is applied to the pinion gear 5 by the reversed power of the twisted spline at the time of overrun since the end face 15A of the inner bearing 15 is facing and arranged contactable to the end face 26A of the clutch inner 26. Moreover, by the reaction of this return power, the end face 26A of the clutch inner 26 contacts the end face 15A of the inner bearing 15, thus the inclination of the output shaft 4 can be regulated by the clutch inner 26 that follows the end face 15A of the inner bearing 15, resulting that deterioration of idling performance can be prevented at the time of a high velocity revolution.

Further, since the inner bearing 15 is located where it overlaps the inside of the washer 31, which prevents the clutch inner 26 to escape and come out in the direction of the axis against the clutch outer 24, a space that will play the role of collecting the oil will be formed between the inner diameter of the washer 31 and the outer diameter of the output shaft 4. Consequently, the lubricating oil filled up between the end face 15A of the inner bearing 15 and the end face 26A of the clutch inner 26 is prevented to be dispersed outside by centrifugal force, which improves the anti-seizing ability.

Finally, by satisfying the conditions of formula (3), the washer 31 and the inner bearing 15 will always overlap irrespective of the directional position of the axis of the output shaft 4. Consequently, it becomes possible to keep the lubricating oil without dispersing outside by centrifugal force.

This invention, however, is not limited to the embodiment mentioned above, and needless to say, it is possible to give various changes in the range which does not deviate from the main point of this invention.

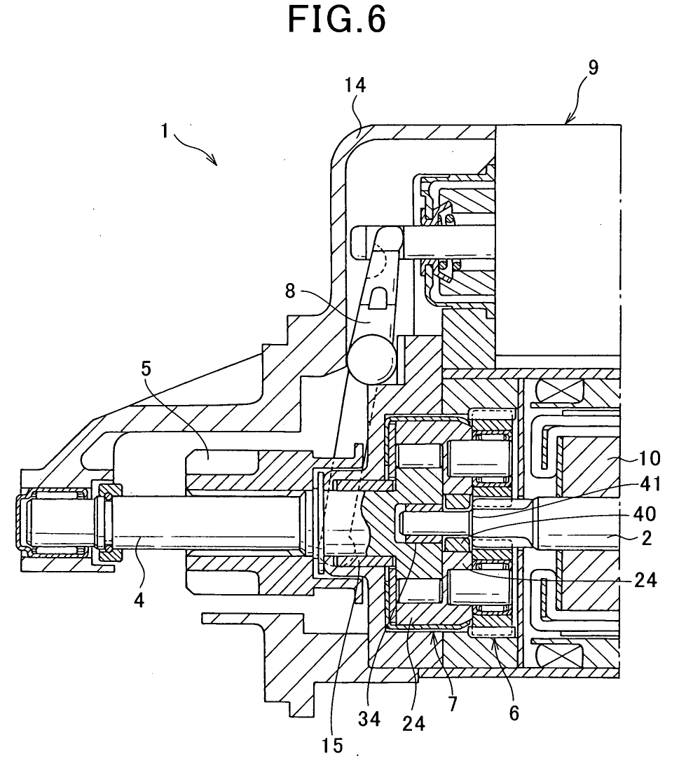

FIG. 6 is an axial sectional view showing the principal part of the starter of the second embodiment of the present invention. This embodiment is an example that constitutes the outer regulating part 40 from the planet carrier 24 of the clutch outer 24 and another member.

As shown in FIG. 6, the clutch outer 24 is provided with a through hole 41 formed in the central part of the diameter direction of the planet carrier 24. The outer regulating part 40 having a ring form is inserted into the inner circumference of the through hole 41. According to this composition, the outer regulating part 40 can be made from different material from that of the clutch outer 24.

In addition, although the starter 1 shown in the first embodiment and the second embodiment has the composition in which the output shaft 4 does not move against the one-way clutch 7, but the pinion gear 5 moves alone in the perimeter of the output shaft 4. However, this invention can be applied also to the starter 1 having the composition of the output shaft 4 and the pinion gear 5 moving together as one piece against the one-way clutch 7. Although not illustrated in detail, the inner axis part 26a of the clutch inner 26 maybe provided in the shape of a cylinder type, and the output shaft 4 maybe inserted in a circumference of the inner axis part 26a so that the output shaft 4 and the inner axis part 26a are connected via helical spline engagement, for example.

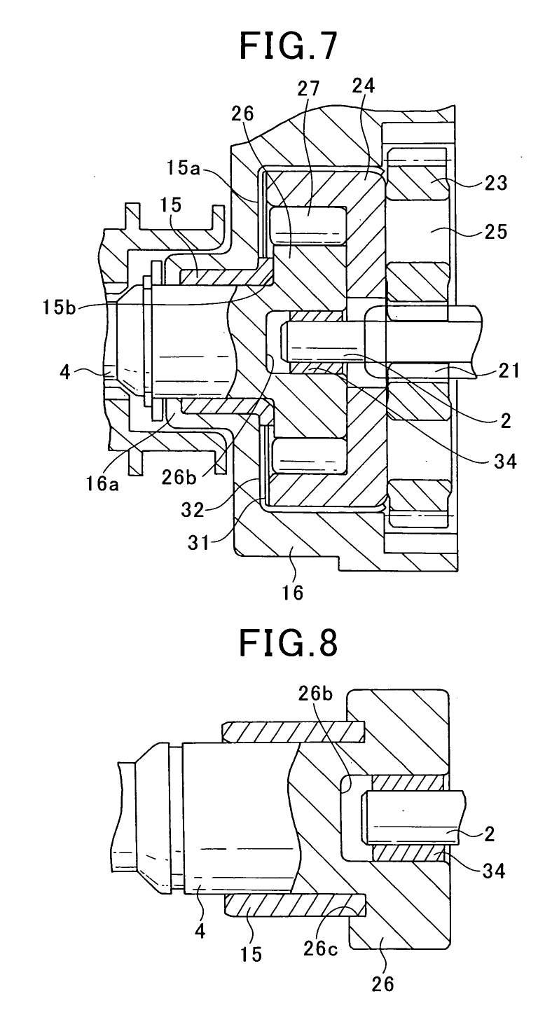

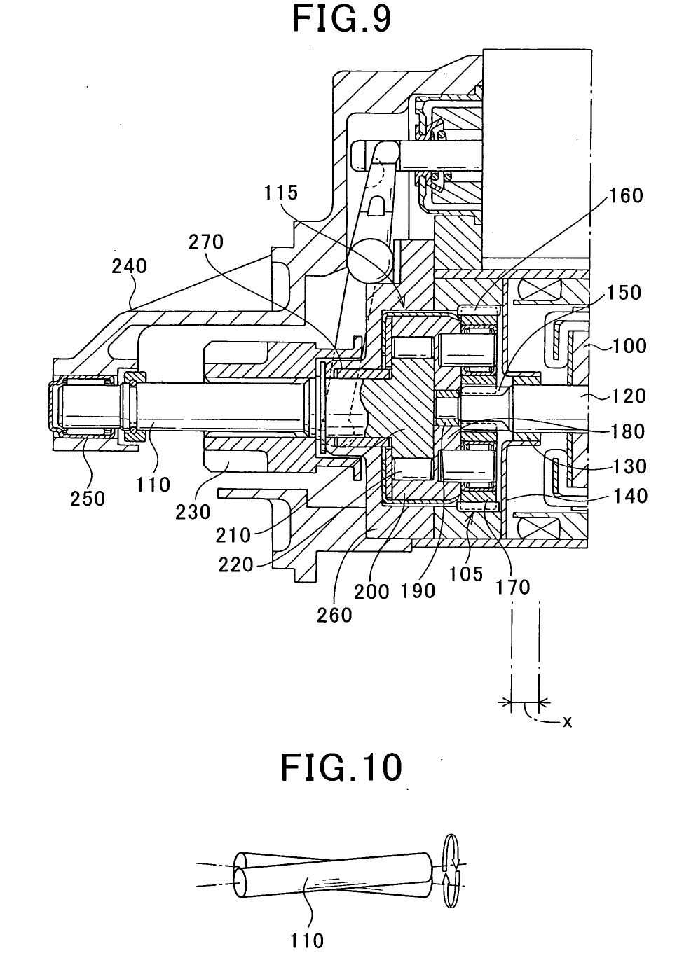

FIG. 7 is an axial sectional view showing the circumference of the clutch in the third embodiment of the present invention. As shown in FIG. 7, a flange part 15a maybe provided in the end part of the inner bearing 15, which projects outward the direction of its diameter. According to this embodiment, the inclination of the output shaft 4 can be more certainly controlled by enlarging the diameter of contact with the end face of the clutch inner 26, but without enlarging the diameter of the inner bearing 15 provided in the center housing 16.

Moreover, there is a chamfer 15b provided in the inner surface of the flange part 15a that is projecting outwardly, therefore, in this embodiment, the effect of collecting the oil can be improved further by increasing both the size of the chamfer 15b of the inner bearing 15. Furthermore, processing of the output shaft 4 becomes easy and the strength of the output shaft 4 can be improved by setting the size of the corner R in the boundary of the output shaft 4 and the clutch inner 26 larger.

Although the end face 15A of the inner bearing 15 is facing and arranged contactably to the end face 26A of the clutch inner 26 in the above mentioned embodiment, a concave groove 26c along the perimeter of the output shaft 4 may be provided in the front end part of the clutch inner 26, as shown in FIG. 8, so that at least a part of the inner bearing 15 (specifically back end part of the inner bearing 15) may fit into the concave groove 26c of the clutch inner 26.

In addition, FIG. 8 is an axial sectional view showing the inner bearing 15 and the clutch inner 26 in the fourth embodiment. According to this embodiment, the inclination of the output shaft 4 is regulated by the rear end part of the inner bearing 15 contacting the inner surface of a wall of the concave groove 26c. Consequently, the deflection of the output shaft 4 at the time of the high velocity revolution can be prevented, and the worsening of idling performance can be prevented. The effect of keeping the lubricating oil filled up between the inner bearing 15 and the clutch inner 26 can be improved as well.

In short, if the starter 1 has the composition that the inner bearing 15 is arranged contactably to the clutch inner 26, the returning power is applied to the pinion gear 5 by the anti-power of the twisted spline at the time of overrun, and the clutch inner 26 contacts the inner bearing 15 by the reaction of the returning power, the inclination of the output shaft 4 can be regulated, and the deflection of the output shaft 4 at the time of a high velocity revolution can be prevented, thus the deterioration of idling performance can be prevented.

What is claimed is:

1. A starter for engines comprising:
an electric motor that generates a torque and has an armature shaft;
a planetary speed reducer that has a sun gear and a planetary gear, wherein the sun gear is provided on the armature shaft, and the planetary gear revolves around a circumference of the sun gear while the planetary gear rotates in order to reduce the revolving speed of the armature shaft;
a one-way clutch, which transmits the torque of the electric motor increased by the speed reducer to an output shaft, having a clutch outer and a clutch inner provided rotatable relative to each other, a wedge-shaped cam chamber formed between the clutch outer and the clutch inner, and a roller contained in the cam chamber;
a planet carrier, which is driven by the orbital motion of the planetary gear, being formed as one with the clutch outer;
an outer regulating part having a round hole formed in the central part of the planet carrier in the direction of its diameter; and
a concave section drilled in the central part of the clutch inner that is supported by a center housing rotatably via an inner bearing;
wherein an end of the armature shaft, disposed on the one-way clutch side from the part where the sun gear is provided, passes through the round hole of the outer regulating part and inserted into an inner circumference of the concave section, and is supported rotatable relative to each other by the clutch inner via an armature shaft bearing.

2. A starter for engines of claim 1, wherein suppose a size difference of the inner diameter of the round hole of the outer regulating part and the outer diameter of the armature shaft which passes through the round hole is 2a, a bearing clearance in the inner circumference or perimeter side of the armature shaft is 2b, and an amount of a maximum separation which the rollers can separate from a perimeter side of the clutch inner at the time of overrun of the one-way clutch is set to c, the condition given by the formula c>a+b is satisfied.

3. A starter for engines of claim 2, wherein suppose an amount of a maximum eccentric value of the clutch outer produced when the two rollers which adjoin each other in the direction of a circumference dig into narrower sides of the cam chambers is set to d, the condition given by the formula a+b>d is satisfied.

4. A starter for engines of claim 1, wherein the clutch outer is provided with a through hole formed in the central part of the diameter direction of the planet carrier, and the outer regulating part having a ring form is inserted into the inner circumference of the through hole.

5. A starter for engines of claim 1, wherein the inner bearing is arranged contactably to the clutch inner.

6. A starter for engines of claim 5, wherein an end face of the inner bearing is facing and arranged contactably to an end face of the clutch inner.

7. A starter for engines of claim 5, wherein the inner bearing is located where it overlaps an inside of a washer, which prevents the clutch inner to escape and come out in the direction of the axis against the clutch outer.

8. A starter for engines of claim 7, wherein suppose a width of a crevice between an edge surface of the clutch inner and an edge surface of the inner bearing in the state where the output shaft is located in the electric motor side of the center housing is set to e, and a thickness of the washer is set to f, the condition given by the formula e<f is satisfied.

9. A starter for engines of claim 5, wherein a flange part, which projects outward the direction of its diameter, is provided in the electric motor side end of the inner bearing.

10. A starter for engines of claim 9, wherein a chamfer is provided in an inner surface of the flange part.

11. A starter for engines of claim 5, wherein a concave groove along the perimeter of the output shaft is provided in the anti-motor side of the clutch inner, and at least a part of the inner bearing is fit into the concave groove of the clutch inner.
